(19) United States
(12) Patent Application Publication
(10) Pub. No.: US 2020/0048900 A1
(43) Pub. Date: Feb. 13, 2020

(54) Door for a Partition Wall, and Partition Wall

(71) Applicant: Maars Holding B.V., Harderwijk (NL)

(72) Inventors: Willem Anne Theodoor Menzo, Zwolle (NL); Pieter Marcel De Graaf, Biddinghuizen (NL)

(21) Appl. No.: 16/607,687

(22) PCT Filed: Apr. 19, 2018
(86) PCT No.: PCT/NL2018/050248

§ 371 Date: Oct. 23, 2019

(30) Foreign Application Priority Data
Apr. 24, 2017 (NL) 2018769

(51) Int. Cl. E04B 2/74; E04B 2/82; E05D 7/083; E05D 11/10; E05F 1/12; E06B 5/16

(52) U.S. Cl. CPC E04B 2/7459; E04B 2/82; E05D 7/083; E05D 11/1028; E05Y 2900/142; E06B 5/16; E04B 2/7411; E04B 2/7412; E04B 2/7455; E05F 1/12

(57) ABSTRACT

Door for a partition wall, comprising a door leaf with an underside to be directed toward a floor and an upper side to be directed toward a ceiling, wherein adjusting means configured to adjust the door leaf in the height relative to the floor are provided close to at least one of the underside and the upper side of the door leaf.

The present invention relates to a door for a partition wall, comprising a door leaf with an underside to be directed toward a floor and an upper side to be directed toward a ceiling. The present invention further relates to a partition wall comprising a horizontal upper post to be mounted on a ceiling, a horizontal lower post to be mounted on a floor, and a wall element, comprising at least a wall panel, to be arranged between the upper post and the lower post.

Known partition walls are used in various kinds of interior construction, for example in office buildings, airports, hospitals, industrial estates, public institutions, schools, hotels, cinemas and retail establishments. Doors in the known partition walls are generally placed with interposing of a door frame, which is configured such that it forms a stop for a door, that a door remains closed in its closed state by means of a recess provided in the door frame, and that it provides mechanical stability to the door and the adjacent wall parts. For aesthetic reasons there is further an increasing demand for partition wall components which are optionally integrally formed and which connect substantially seamlessly to each other, such as frameless doors. The use of frameless doors is however at odds with the preference for modular construction of partition walls from prefabricated components as far as possible in respect of dimensions and choice of materials.

It is an object of the invention to improve the prior art, i.e. to provide a high-grade partition wall which meets the high demands regarding the appearance of the partition wall, wherein a frameless door can be applied without being to the detriment of the modular construction of the partition wall from prefabricated components.

According to a first aspect thereof, the invention provides for this purpose a door of the type stated in the preamble, with the special feature that adjusting means configured to adjust the door leaf in the height relative to the floor are provided close to at least one of the underside and the upper side of the door leaf. Using these adjusting means it is possible to arrange the door leaf at a desired height relative to the floor and the ceiling, whereby it is easily possible to compensate for unevenness in the floor and/or the ceiling (for example in the case of a floor and/or ceiling which is not level), while the height dimension of the door leaf can be made as great as possible in order to bring about the most seamless connection possible to the floor and the ceiling. This is because the invention makes it possible to adjust the door leaf in the height relative to the floor surface and ceiling surface and then fix it in the desired position. Moreover, at least the lower edge, and preferably also the upper edge, of the door leaf can be placed at the same height as a lower edge, preferably also an upper edge, of an adjacent wall panel. This provides the particular advantage that the adjustments which are generally essential for frameless doors, such as making the doors for placing to size and precisely positioning and adjusting the hinges, are not necessary. In other words, the invention provides on the one hand an aesthetically high-quality door module which, visually, almost disappears in a partition wall constructed from wall elements. On the other hand, the door meets the demands of modularity of partition walls, since the dimensioning and the choice of material of the door can be predetermined before it is placed on location as part of a partition wall between the wall elements thereof.

In a preferred embodiment of the door according to the present invention the adjusting means comprise a first elongate profile and a second elongate profile formed correspondingly to the first profile, wherein the first and the second profile extend in the width direction of the door and wherein the first profile is fixedly connected to the door leaf and is configured such that it forms a receiving element for receiving the second profile therein in releasably attachable and height-adjustable manner, and a hinge element connected to the second profile for pivoting the second profile about a vertical axis of the door leaf, wherein the hinge element can be mounted on a wall and/or one of the floor and the ceiling. The door leaf therefore supports on the second profile and the hinge element connected thereto. The combination of the two profiles, wherein the one profile can be received in height-adjustable manner in the other profile, provides as it were a telescopic construction whereby the door leaf of the door can be adjusted in the height relative to the floor and the ceiling. A space between the first and the second profile preferably comprises an element of sound-insulating material, which contributes to the intended high functional quality of the door. It is noted that the door leaf preferably comprises a self-supporting construction. The door leaf particularly comprises a self-supporting door shell, preferably a self-supporting assembly of an inner and an outer door shell.

In a preferred embodiment the first elongate profile has a U-shaped cross-section and a base of the U-shaped cross-section is fixedly connected to the door leaf such that legs of the U-shaped cross-section extend at least substantially parallel to the vertical axis from the base in a direction remote from the door leaf, and a cross-section of the second elongate profile is formed such that it is releasably attachable to the first profile, such that it is adjustable along the vertical axis relative to the first profile. The second elongate profile preferably has a U-shaped cross-section and the bases of the U-shaped cross-sections of the first and the second profile are directed away from each other or directed toward each other, and the distance between the bases of the U-shaped cross-sections of the first and the second profile is preferably adjustable in order to adjust the door leaf in the height.

In a preferred embodiment the door further comprises height-adjustable spacing means between the bases of the U-shaped cross-sections of the first and the second profile for the purpose of adjusting the distance between said bases. Such spacing means can be embodied as adjusting screws or wedges or made-to-measure spacer blocks of inelastic material. The spacing means preferably comprise the above stated element of sound-insulating material. In the preferred embodiment wherein the bases of the U-shaped cross-sections are directed away from each other the spacing means comprising the sound-insulating material are in particular arranged, optionally clamped, between said bases.

In a preferred embodiment the cross-section of the second profile is dimensioned such that the legs of the U-shaped cross-section of the first profile embrace the second profile, such that the first profile engages, optionally clampingly, on the second profile. As stated, the first and second profiles preferably take a telescopic form, wherein unevenness in the floor and/or the ceiling can be compensated by means of mutually sliding the profiles telescopically into or out of each other. The relative height position of the first and second profiles can thus be adjusted, and be fixed using spacing means between the profiles, such as spacer blocks.

In a preferred embodiment the door further comprises at least a third elongate profile which extends in the width direction of the door and is formed and dimensioned such that it engages, optionally clampingly, on the second profile. Such a third profile is preferably provided with an elongate strip of optionally elastic and draught-excluding and/or sound-insulating material which is arranged over substantially the whole length of the third profile on a side of the third profile directed toward the floor and/or the ceiling. A strip of such material is preferably dimensioned such that this strip is at least in contact with the floor and/or the ceiling when the door is closed. The third profile is preferably arranged for moving slidably along the vertical axis relative to the second profile. A particular advantage of such a third profile movable in the height is that, in combination with the strip of optionally elastic and draught-excluding and/or sound-insulating material, it can function as a drop seal.

Such a third profile with said strip, functioning as door seal or drop seal, is preferably arranged on either side, i.e. on the front side and the rear side, at the position of the underside and/or upper side of the door.

In a preferred embodiment the door leaf comprises close to at least one of the underside and the upper side of the door leaf a recess extending in the width direction of the door for at least partially receiving therein at least one of the first, the second and the third profile. A particular advantage of such a recess is that the height dimension of at least one of the visual surfaces of the door leaf can be maximized in order to realize the most seamless connection possible to the floor and/or the ceiling.

In a preferred embodiment the second profile comprises close to a longitudinal outer end thereof a recess for receiving therein a mounting part of the hinge element. As stated, the door leaf supports via the first profile and the spacing means on the second profile which is connected to the hinge element, whereby the height of the door leaf relative to the hinge element and therefore relative to the floor and/or the ceiling can be adjusted. In a preferred embodiment the hinge element comprises a pivot hinge and the recess is configured to receive therein a pin of the pivot hinge. A particular advantage of such a pivot hinge is that it substantially disappears in the door leaf, so that it is at least substantially invisible when the door is arranged in the partition wall.

In a preferred embodiment the hinge element comprises a pivot hinge and the second profile comprises close to a longitudinal centre thereof a recess for receiving therein a pin of the pivot hinge. As a result, the door is rotatable about its longitudinal axis. A particular advantage hereof is that the centre of gravity of the door lies above the axis of the pin of the pivot hinge. In other words, the point of rotation of the door lies directly below the centre of gravity of the door. This results in a balanced distribution of the weight of the door relative to the point of rotation. This prevents lateral forces being exerted on the hinge pin. This results in less (to no) wear of the hinge element and a lighter operation of the door compared to pivot-hinged doors wherein the pivot hinge is arranged eccentrically relative to the longitudinal axis of the door. A pivot hinge arranged on the longitudinal centre moreover enables the door to be rotated about its longitudinal axis through 360 degrees. A particular advantage hereof is that a front and a rear side of the door can be turned both toward the inside and toward the outside of the space to be partitioned with the partition wall. An entirely different door appearance can thus be created by simply turning the door around.

In a preferred embodiment the pivot hinge comprises a mounting part for mounting the pivot hinge on the floor or the ceiling, and a locking mechanism for locking the door in a plurality of predetermined angular positions relative to a frontal plane of the wall. A significant advantage of such a locking mechanism is that the door can be fixed in its closed position or in various open positions. The accessibility to the space to be partitioned with the partition wall can be controlled in this way.

The locking mechanism preferably comprises a locking member arranged in the second profile under spring pressure, and locking holes formed correspondingly to the locking member and arranged in the mounting part at a mutual distance along a circle, wherein the locking member is resiliently movable between a rest position, in which the locking member extends into one of the locking holes in the mounting part, and a retracted position in which the locking member is situated at least substantially wholly in the second profile. The positions of the locking holes along the circle determine the positions in which the door can be locked relative to the frontal plane of the partition wall.

An outer wall of the locking member and/or an inner wall of each of the locking holes is preferably chamfered or rounded such that the locking member can be carried from its retracted position to its rest position in a manner in which it snaps into the locking holes only by means of rotation of the door, and vice versa.

In another preferred embodiment the hinge element comprises a paumelle hinge, and the second profile is configured close to a longitudinal outer end thereof for mounting thereon a mounting part of the paumelle hinge. A particular advantage of such a paumelle hinge is that it allows the door connected thereto to move between a closed and an open position through an angle of 180 degrees. The door can hereby be placed at least substantially flat against the adjacent wall element, which ensures that, in its open position, as little of the door as possible is situated in the passage of the door opening. This is particularly advantageous in situations where a continuous passage is desired for a longer period of time.

The hinge element preferably comprises a spring element and/or spring mechanism for urging the door into a predetermined position using spring force. In this way it can for instance be achieved that an opened door always falls shut, in a manner which may or may not be controlled, in the plane of the partition wall or remains open perpendicularly of the plane of the partition wall.

In a preferred embodiment the door leaf is manufactured from at least one from the group of the following materials: steel, glass, plastic and wood. In other words, the door provides an integral system solution for partition walls for diverse fields of application.

In a preferred embodiment the door leaf comprises a self-supporting construction. This self-supporting construction preferably comprises first and second shells disposed parallel to each other and opposite each other and extending in the plane of the partition wall, wherein the first and second shells are thermally disconnected from each other. The first and second shells are more preferably manufactured from steel, wherein a fire-resistant material, such as a gypsum fibre board, is arranged between the first and second shells in order to thermally disconnect the first and second shells from each other. A particular advantage of a door embodied in such a manner is that it helps prevent undesirably large gaps from being created between the wall element and the door in the case of for instance fire, particularly in partition walls manufactured from steel. This greatly enhances the fire-resistance of such partition walls. It is noted that the first and second shells preferably form a front side and a rear side of the door leaf.

According to a second aspect, the invention provides a partition wall of the type stated in the preamble, with the special feature that it comprises a door according to an embodiment of the present invention to be arranged at least substantially directly against an end surface of the wall element, wherein the wall panel and the door leaf of the door have the same height dimension and at least the lower post extends up to the door, such that the lower post does not extend under the door. The upper post preferably likewise extends up to the door, such that the upper post does not extend above the door. Since the partition wall comprises a door according to an embodiment of the present invention it is possible to arrange the door leaf at a desired height relative to the floor and the ceiling, whereby it is easily possible to compensate for unevenness in the floor and/or the ceiling (for example in the case of a floor and/or ceiling which is not level), while the height dimension of the door leaf can be made as great as possible in order to achieve the most seamless connection possible to the floor and the ceiling. This is because the invention makes it possible to adjust the door leaf in the height relative to the floor surface and the ceiling surface and then fix it in the desired position. Moreover, at least the lower edge, and preferably also the upper edge, of the door leaf can be placed at the same height as a lower edge, preferably also an upper edge, of an adjacent wall panel. This provides the particular advantage that the adjustments which are generally essential for frameless doors, such as making the doors for placing to size and precisely positioning and adjusting the hinges, are not necessary. Since the door can be arranged directly against the vertical post and the lower post and the upper post do not extend respectively under and above the door, the door can be placed substantially seamlessly between adjacent wall elements and floor and ceiling lying below and above. In other words, the invention provides on the one hand an aesthetically high-quality door module which, visually, almost disappears in a partition wall constructed from wall elements. On the other hand, the door meets the demands of modularity of partition walls, since the dimensioning and the choice of material of the door can be predetermined before it is placed on location as part of a partition wall between the wall elements thereof. As stated, the wall panel and the door leaf are here preferably arranged at the same height above the floor, such that a horizontal lower edge of the wall panel and a horizontal lower edge of the door leaf lie mutually in line at the same height above the floor.

In a preferred embodiment the wall element comprises a first and a second wall panel extending parallel to each other between an upper side and an underside of the wall element, wherein the wall element is configured close to the upper side and the underside thereof to be arranged standing upright between the horizontal upper post and the horizontal lower post, wherein an elongate profile extending between the upper and underside is arranged between the first and the second wall panel close to a lateral end surface of the wall element, and one of the first and the second wall panel extends beyond the other of the first and the second wall panel in horizontal direction, and wherein an elongate covering element extending between the upper side and underside is arranged on the profile on an outer side of the lateral end surface. The profile arranged between the first and the second wall panel provides mechanical stability to the wall element at the position of the profile, whereby said lateral end surface can function as vertical door post from a mechanical viewpoint. A particular advantage of the one wall panel extending beyond the other one in horizontal direction is that it can function as a stop for closing thereagainst a door to be placed in the partition wall. The elongate covering element has the particular advantage that the profile is concealed from view, especially when the first and the second panel are manufactured from a non-transparent material such as steel, which gives the partition wall a substantially seamless and sleek appearance, also at the position of the substantially invisible transition between the wall element and a door to be placed adjacently thereof and substantially directly thereagainst. In addition to the stiffening function of said profile, the elongate covering element also provides stiffness to the wall element at the position of the profile and the covering element. In other words, the invention provides a wall element for a partition wall which functions in aesthetically high-quality manner as a frame for a door to be placed thereagainst. It is noted that the profile and the covering element are not necessarily only mutually co-acting separate components, but can also be manufactured integrally together. It is also noted that the profile can comprise at least a part of a vertical wall post, preferably of a clamping post, of the partition wall.

In a preferred embodiment the profile has an at least substantially U-shaped cross-section comprising a base and two legs, wherein the covering element is arranged on the base and wherein each leg comprises a laterally outward directed wing. The wing is preferably formed such that it can receive a tongue of at least one of the wall elements thereunder for the purpose of attaching said one wall element to the profile.

In a preferred embodiment the covering element has a substantially L-shaped cross-section, comprising a first leg extending in the depth direction of the wall element and a second leg lying at least substantially perpendicularly thereof and extending in the width direction of the wall element, wherein the covering element is arranged such that the first leg covers the profile and the second leg covers at least a portion of the one of the first and the second wall panel which extends beyond the other of the first and the second wall panel in horizontal direction. A covering element with such a form imposes the position of the covering element on the profile and said one wall panel and covers a possible gap between the profile and said one wall panel. A particular advantage hereof is that a neat finish of the lateral end surface of the wall element is achieved. A thickness of the covering element preferably lies between 1 mm and 5 mm, more preferably between 1 mm and 3 mm. A particular advantage of such a thin covering element is that a door to be placed can be arranged very closely against and thus substantially directly against the wall element.

In a preferred embodiment the covering element and/or the profile is made at least partially of a heat-insulating material in order to thermally disconnect the first and second wall panels from each other. A particular advantage of such a covering element and/or profile is that it helps prevent undesirably large gaps from being created between the wall element and the door in the case of fire, particularly in partition walls manufactured from steel. This greatly enhances the fire-resistance of such partition walls.

In a preferred embodiment the wall element and the door are manufactured from the same material, wherein the material is chosen from the following group of materials: steel, glass, plastic and wood. A partition wall wherein the wall element and the door are made from the same material contributes to the aesthetically high-quality appearance thereof and meets the increasing demand for integrally formed partition wall components which connect seamlessly to each other.

In a preferred embodiment the lower post and/or the upper post comprise a first, second and third elongate profile with a U-shaped cross-section, wherein the first profile is mounted with a base of its U-shaped cross-section on the floor, wherein the second profile is arranged on the first profile, wherein bases of the U-shaped cross-sections of the first and the second profile are directed away from each other, wherein the third profile is arranged between the first profile and the second profile, wherein bases of the U-shaped cross-sections of the first and third profiles are directed away from each other. It is hereby easily possible to compensate for unevenness in the floor and/or ceiling (for example in the case of a floor and/or ceiling which is not level), while the height of the lower post and/or upper post can be made as small as possible. This is because the invention makes it possible to adjust the first, second and third profiles in the height relative to each other, relative to the floor and/or the ceiling, and then fix them in a desired position. The legs of the U-shaped cross-sections of the first, second and third profiles of the lower post and/or upper post particularly comprise mutually co-acting ridges in order to prevent for instance the second and third profiles dropping down during installation. The first, second and third profiles preferably take a telescopic form, wherein unevenness in the floor and/or the ceiling can be compensated by means of mutually sliding the profiles telescopically into or out of each other. The relative height position of the first, second and third profiles can thus be adjusted, and be fixed using spacing means between the profiles, such as spacer blocks.

In a preferred embodiment the base of the U-shaped cross-section of the second profile comprises a resilient clamping profile arranged thereon, and the first and/or the second wall panel comprises, arranged on its lower edge, an inward extending tongue arranged clampingly between the base of the U-shaped cross-section of the second profile and the resilient clamping profile in order to attach the first and/or the second wall panel to the lower post and/or the upper post. It is hereby easily possible to place the panel in the wall (by moving the panel in vertical state in horizontal direction, whereby the tongue is received in a slot of the clamping profile), anchor it therein and, if desired, remove it again. The panel is preferably a glass panel, wherein the tongue arranged on its lower edge extends inward, i.e. is directed toward the wall. At least two panels are preferably placed on either side of the lower post and the upper post, wherein the panels are arranged clampingly between the upper post and the lower post. The use of a clamping profile enables the wall to be made to any desired length, for instance by sawing, whereby varying dimensions can be easily achieved with one (standard) clamping profile. The tongue arranged on the lower edge of the first and/or the second wall panel and the tongue arranged on the upper edge of the first and/or the second wall panel preferably extend along the whole width of the panel. The tongue arranged on the lower edge of the first and/or the second wall panel and the tongue arranged on the upper edge of the first and/or the second wall panel are more preferably each provided with a profiled, longitudinal insertion edge. The insertion edges preferably comprise an obliquely rising insertion surface.

According to a third aspect of the invention, a partition wall is provided comprising at least a first and a second door according to an embodiment of the present invention to be arranged between a ceiling and a floor, wherein the door comprises a pivot hinge, wherein each of the first and the second door is movable between a closed position, in which a frontal plane of the door lies in a frontal plane of the partition wall, and an open position in which the frontal plane of the door lies at an angle relative to the frontal plane of the partition wall, wherein the first door and the second door are arranged adjacently of each other such that together they form one at least substantially continuous surface in their closed position, such that they collectively function as one wall element of the partition wall. A particular advantage of such a partition wall is on the one hand that the doors as such can serve as wall element parts of a partition wall and on the other hand that such a partition wall can be opened over its whole length by placing each door in its open position. In this way large partition walls for partitioning large spaces can for instance be realized using only doors.

A particular advantage hereof is that the size of the overall passage opening in the partition wall can easily be increased or decreased by means of opening respectively more or fewer doors functioning as wall element. This is particularly advantageous if the space has to be suitable for both large and small groups of people. The inflow and the outflow of people into and out of the space to be partitioned can for instance be controlled hereby. In addition, it is hereby possible to control the degree of ventilation of the space to be partitioned.

The pivot hinge of the at least first and second door is preferably situated close to the longitudinal axis of each of said doors. A particular advantage hereof is that this makes it possible to rotate the doors about their longitudinal axes through 360 degrees. A particular advantage hereof is that a front side and rear side of the doors can be turned both toward the inside and toward the outside of the space to be partitioned with the partition wall. An entirely different appearance of a part of or of the whole partition wall can thus be achieved by simply turning the door around.

The present invention is further elucidated on the basis of the following figures which show preferred embodiments of the door and the partition wall according to the present invention and are not intended to limit the scope of protection of the invention in any way, wherein:

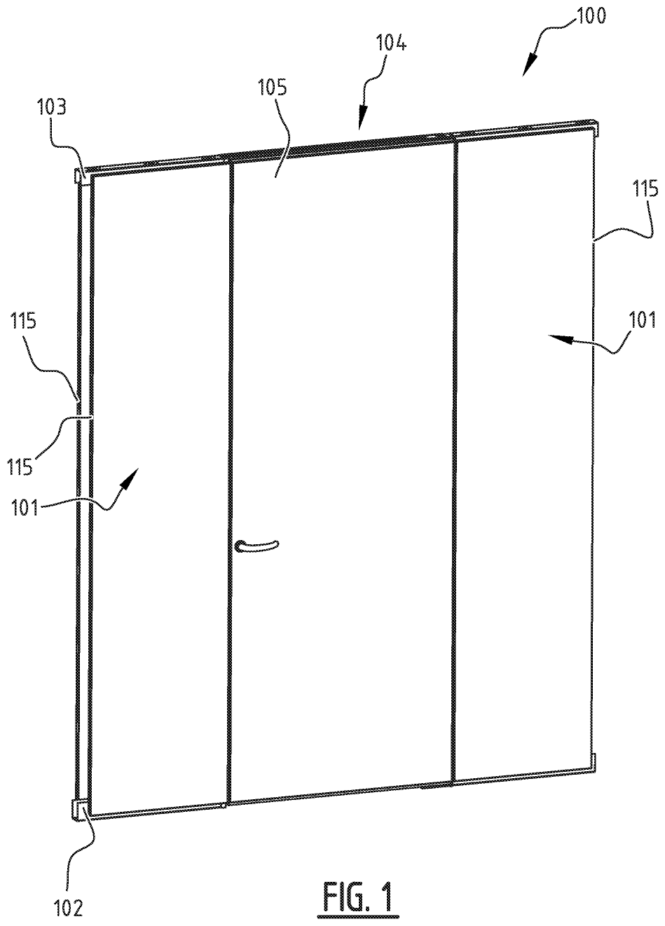

FIG. 1 shows a perspective view of an embodiment of a partition wall according to the invention;

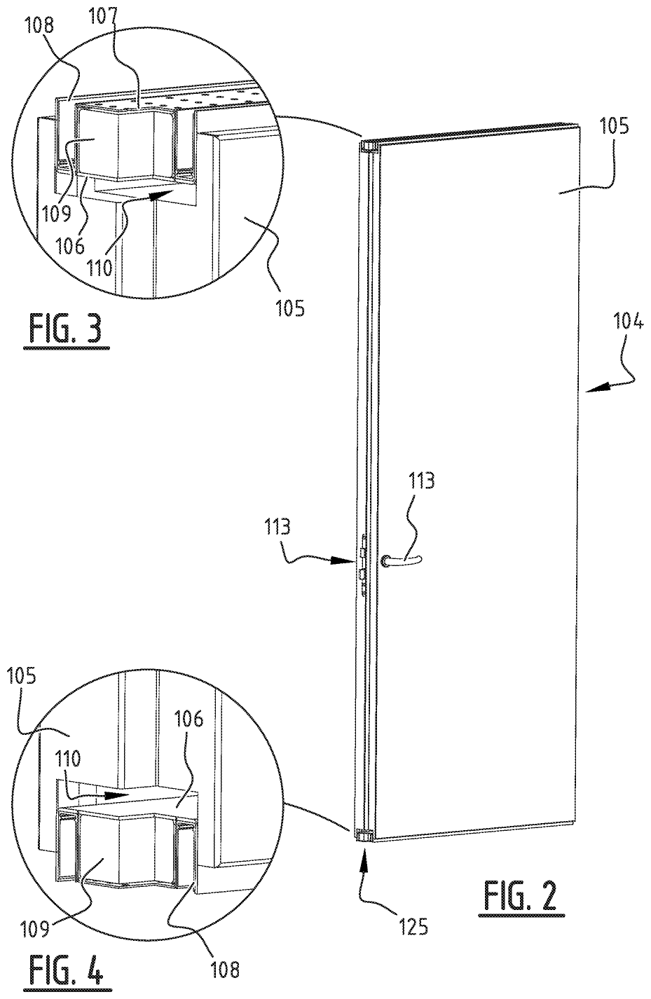

FIG. 2 shows a perspective view of an embodiment of a door according to the invention;

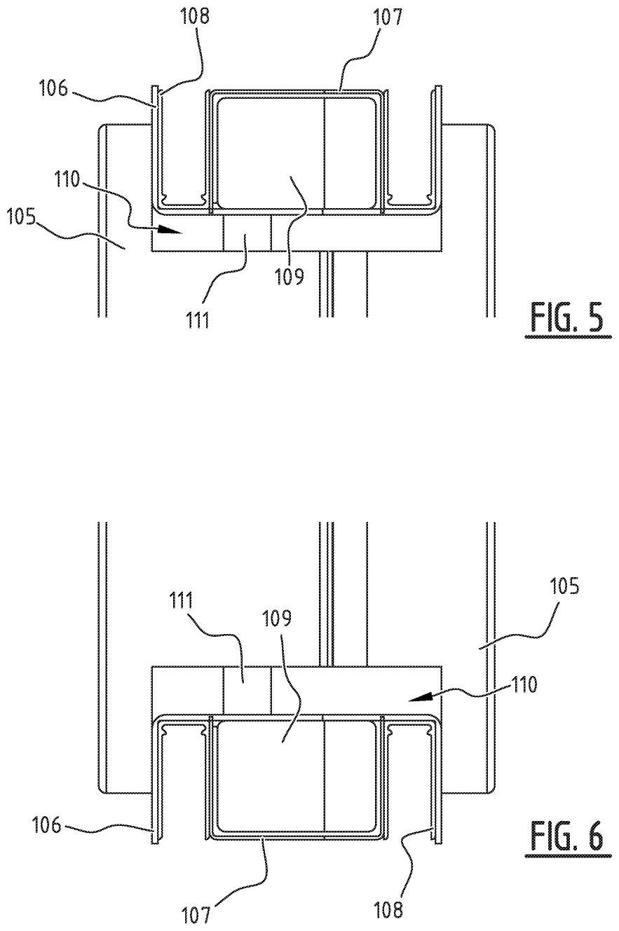

FIGS. 3 and 4 each show a detail of FIG. 2 in perspective view;

FIGS. 5 and 6 each show a side view of the details shown in respectively FIGS. 3 and 4;

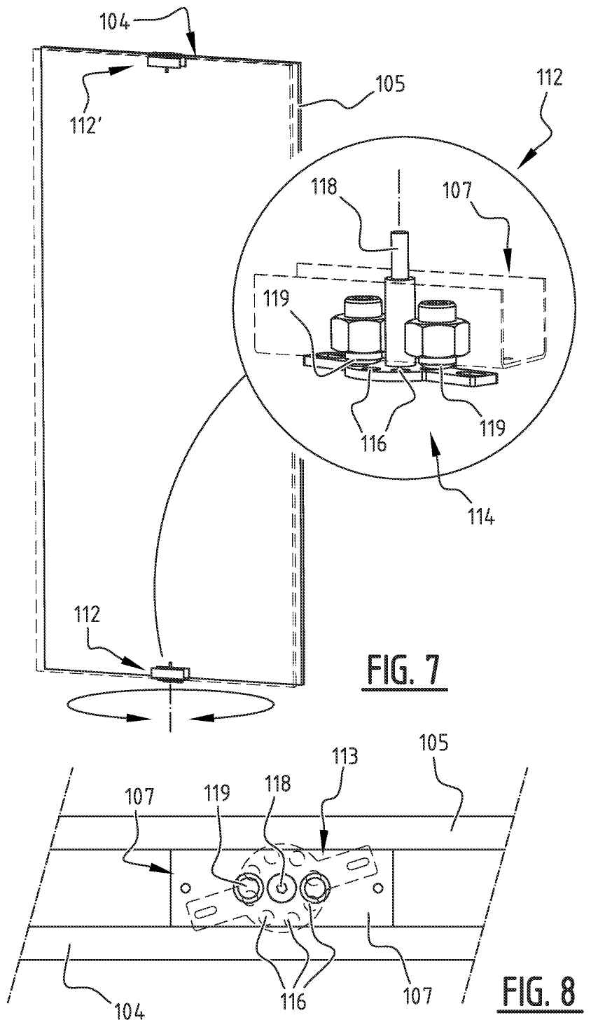

FIG. 7 shows a perspective view of an embodiment of a door according to the invention and a detail thereof;

FIG. 8 shows a bottom view of the door of FIG. 7; and

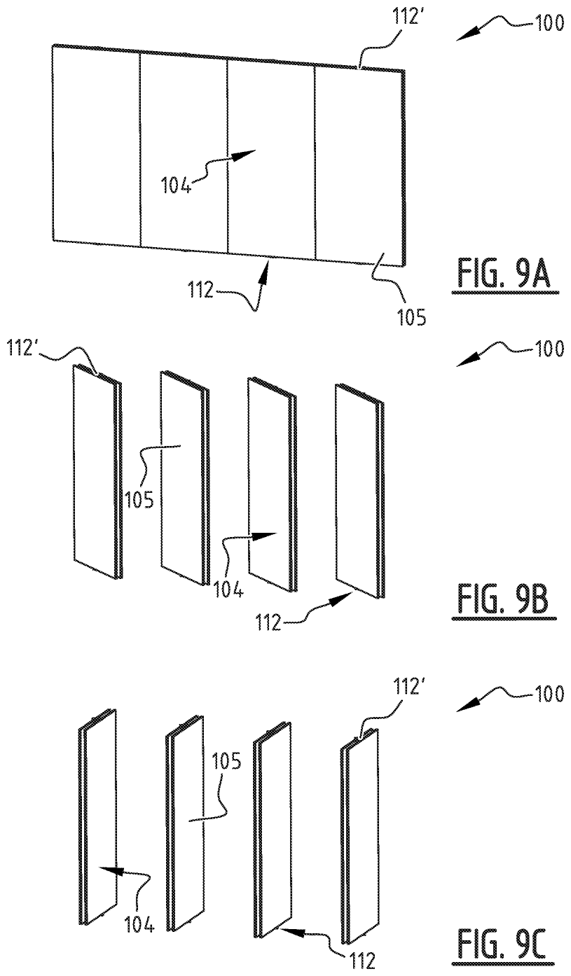

FIGS. 9A, 9B and 9C show perspective views of an embodiment of a partition wall according to the invention.

FIG. 1 shows a perspective view of an embodiment of a partition wall 100 consisting of a left-hand and a right-hand wall element 101, a horizontal upper post 103 to be mounted on a ceiling, a horizontal lower post 102 to be mounted on a floor, wherein wall elements 101 are arranged between upper post 103 and lower post 102. Partition wall 100 further comprises a door 104 arranged at least substantially directly against end surfaces of wall elements 101, wherein wall panels 115 and a door leaf 105 of door 104 have the same height dimension. In the shown embodiment lower post 102 and upper post 103 extend up to door 104, such that lower post 102 and upper post 103 do not extend respectively under and above door 104.

FIG. 2 shows a perspective view of an embodiment of door 104. Provided on the underside and the upper side of door leaf 105 are adjusting means 125 which are configured to adjust door leaf 105 in the height relative to the floor and the ceiling. Using these adjusting means 125 it is possible to arrange door leaf 105 at a desired height relative to the floor and the ceiling, whereby it is easily possible to compensate for unevenness in the floor and/or the ceiling (for example in the case of a floor and/or ceiling which is not level), while the height dimension of door leaf 105 can be made as great as possible so that the most seamless connection possible to the floor and the ceiling is obtained. The lower edge and the upper edge of the door leaf can be placed at the same height as the lower edge and the upper edge of an adjacent wall panel 115 using adjusting means 125. The adjustments which are generally essential for frameless doors, such as making the doors for placing to size and precisely positioning and adjusting the hinges, are hereby not necessary.

FIGS. 3 and 4 each show a perspective view of the adjusting means 125 on respectively the upper side and the underside of door 104. FIGS. 5 and 6 show the respective side views thereof. Adjusting means 125 comprise an elongate profile 106 and an elongate profile 107 formed correspondingly to profile 106, wherein profiles 106, 107 extend in the width direction of door 104 and wherein profile 106 is fixedly connected to door leaf 105. In the shown embodiment profile 106 forms a receiving element for profile 107, which can be attached therein in releasable and height-adjustable manner Situated at an outer end of profile 107 close to wall element 101 is a hinge element (not shown) which is connected to profile 107 for pivoting profile 107 about a vertical axis of door leaf 105. Such a hinge element can for instance be mounted on wall element 101 and/or one of the floor and the ceiling. Door leaf 105 supports here on profile 107 and the hinge element connected thereto. The combination of the two profiles 106, 107, wherein profile 107 can be received in height-adjustable manner in profile 106, provides as it were a telescopic construction whereby door leaf 105 of door 104 can be adjusted in the height relative to the floor and the ceiling.

As shown, elongate profile 106 has a U-shaped cross-section. The base of the U-shaped cross-section is then connected to door leaf 105 such that legs of the U-shaped cross-section extend from the base thereof in a direction remote from door leaf 105. Elongate profile 107 further also has a U-shaped cross-section, and the bases of the U-shaped cross-sections of profiles 106, 107 are directed away from each other. The distance between the bases of the U-shaped cross-sections of profiles 106, 107 can be adjusted by means of spacing means, such as spacer blocks 109, between the bases, so that door leaf 105 can be adjusted in the height. Spacing means 109 can here be made of a material which has sound-insulating properties. Profiles 106, 107 thus take a telescopic form, wherein unevenness in the floor and/or the ceiling can be compensated by means of mutually sliding profiles 106, 107 telescopically into or out of each other. The relative height position of profiles 106, 107 can thus be adjusted, and be fixed using spacing means between profiles 106, 107, such as spacer blocks 109.

As shown, adjusting means 125 further comprise two elongate profiles 108 extending in the width direction of door 104. These are formed and dimensioned such that they engage on profile 107 and are able to hold an elongate strip (not shown) of optionally elastic and draught-excluding and/or sound-insulating material. In other embodiments profiles 108 are arranged for moving slidably along the vertical axis relative to profile 107, whereby, in combination with the strip (not shown) of optionally elastic and draught-excluding and/or sound-insulating material, they can function as a drop seal.

Door leaf 105 further has on its underside and upper side a recess 110 for receiving the adjusting means 125 therein. The height dimension of at least one of the visual surfaces of the door leaf can hereby be maximized in order to realize the most seamless connection possible to the floor and/or the ceiling.

Profile 107 further has at an outer end thereof a recess for receiving therein a pin 111 of hinge element, such as a pivot hinge. As stated, door leaf 105 supports via profile 106 and spacing means 109 on the profile 107 connected to the hinge element, whereby the height of door leaf 105 relative to the hinge element and therefore relative to the floor and/or the ceiling can be adjusted.

In an alternative embodiment pivot hinges 112, 112′ are arranged close to a longitudinal axis of door 104 (see FIGS. 7 and 9A-9C), wherein pivot hinge 112 is arranged on the underside of door 104 and pivot hinge 112′ on the upper side of door 104. Door 104 is hereby rotatable about its longitudinal axis. The centre of gravity of door 104 moreover lies respectively above and below the pins 118 of respective pivot hinges 112, 112′, on the axes of pins 118. This results in a balanced distribution of the weight of door 104 relative to the point of rotation, which results in less (to no) wear of pivot hinges 112, 112′ and a light operation of the door compared to pivot-hinged doors 104 wherein the hinges are arranged eccentrically relative to the longitudinal axis of door 104. The pivot hinges 112, 112′ arranged close to the longitudinal axis of door 104 further enable the door 104 to be rotated about its longitudinal axis through 360 degrees, whereby a front side and a rear side of door 104 can be turned toward both the inside and the outside of the space to be partitioned with partition wall 100. Because door 104 can be turned around, a different door appearance can be easily created.

Pivot hinges 112, 112′ comprise mounting parts for mounting the pivot hinges 112, 112′ on respectively the floor and the ceiling. Mounting part 113 of the pivot hinge 112 arranged on the underside of door 104 also forms part of a locking mechanism 114 for locking door 104 in angular positions relative to a frontal plane of wall 100 (see FIG. 7). Locking mechanism 114 comprises a locking ball (or locking pin) 119 arranged in second profile 107 under spring pressure, and locking holes 116 which correspond with locking ball 119 and are arranged in mounting part 113 at a mutual distance along a circle (see the detail drawing of FIG. 7 and FIG. 8). Locking ball 119 is resiliently movable. In its rest position locking ball 119 protrudes into one of the locking holes 116 in mounting part 113. In its retracted position locking ball 119 is situated at least substantially wholly in second profile 107. The positions of locking holes 116 in mounting part 113 therefore determine the positions in which door 104 can be locked relative to the frontal plane of partition wall 100. The outer wall of locking ball 119 is convex on its protruding side. The inner wall of each of the locking holes 116 is chamfered (or rounded). In this way locking ball 119 can be carried from its retracted position to its rest position in a manner in which it snaps into locking holes 116 only by means of rotation of door 104, and vice versa, i.e. locking ball 119 can be carried from its rest position to its retracted position and be guided from locking holes 116 only by means of rotation of door 104. In other words, the chamfered form of said outer wall and inner wall provide for a guiding of locking ball 119 into and out of each of the locking holes 116.

The door 104 as shown in FIG. 7 can also function as wall element 101 of a partition wall 100. Such a partition wall 100 is shown in FIGS. 9A-9C. Partition wall 100 comprises doors 104, arranged between the ceiling and the floor, as shown in FIG. 7. Each of the doors 104 is movable between a closed position, in which a frontal plane of door 104 lies in a frontal plane of partition wall 100 (see FIG. 9A), and an open position in which the frontal plane of door 104 is situated at an angle relative to the frontal plane of partition wall 100 (see FIGS. 9B and 9C). As can be seen in FIGS. 9A-9C, doors 104 are arranged adjacently of each other such that, in their closed position, together they form one continuous surface. As such, together they form one partition wall 100. An advantage of such a partition wall 100 is on the one hand that doors 104 as such can serve as wall element parts 101 of a partition wall 100 and on the other hand that such a partition wall 100 can be opened over its whole length by placing each door 104 in its open position. In this way large partition walls 100 for partitioning large spaces can for instance be realized using only doors 104. An advantage hereof is that the size of the overall passage opening in partition wall 100 can easily be increased or decreased by means of opening respectively more or fewer doors 104 functioning as wall element 101. This is particularly advantageous if the space has to be suitable for both large and small groups of people. The inflow and the outflow of people into and out of the space to be partitioned can for instance be controlled hereby. In addition, it is hereby also possible to control the degree of ventilation of the space to be partitioned.

Since it is possible to rotate doors 104 about their longitudinal axes through 360 degrees, the front side and rear side of the doors can be turned toward both the inside and the outside of the space to be partitioned with partition wall 100. An entirely different appearance of a part of or of the whole partition wall 100 can thus be achieved by simply turning doors 104 around. In this way the function of the space to be partitioned can be adapted in simple manner Outer sides of doors 104 which may be black can for instance be rotated inward in order to achieve a dark space.

The present invention is not limited to the shown embodiments but also extends to other embodiments falling within the scope of protection of the appended claims.

1. Door for a partition wall comprising:
a door leaf with an underside to be directed toward a floor and an upper side to be directed toward a ceiling; and,
adjusting means configured to adjust the door leaf in the height relative to the floor are provided close to at least one of the underside and the upper side of the door leaf.

2. Door as claimed in claim 1, wherein the adjusting means comprise:
a first elongate profile and a second elongate profile formed correspondingly to the first profile, wherein the first and the second profile extend in the width direction of the door and wherein the first profile is fixedly connected to the door leaf and is configured such that it forms a receiving element for receiving the second profile therein in releasably attachable and height-adjustable manner; and
a hinge element connected to the second profile for pivoting the second profile about a vertical axis of the door leaf, wherein the hinge element can be mounted on a wall and/or one of the floor and the ceiling.

3. Door as claimed in claim 2, wherein the first elongate profile has a U-shaped cross-section and a base of the U-shaped cross-section is fixedly connected to the door leaf such that legs of the U-shaped cross-section extend at least substantially parallel to the vertical axis from the base in a direction remote from the door leaf, and wherein a cross-section of the second elongate profile is formed such that it is releasably attachable to the first profile, such that it is adjustable along the vertical axis relative to the first profile.

4. Door as claimed in claim 3, wherein the second elongate profile has a U-shaped cross-section and wherein the bases of the U-shaped cross-sections of the first and the second profile are directed away from each other.

5. Door as claimed in claim 3, wherein the second elongate profile has a double U-shape in cross-section and wherein the bases of the U-shaped cross-sections of the first and the second profile are directed toward each other.

6. Door as claimed in claim 4, wherein the distance between the bases of the U-shaped cross-sections of the first and the second profile is adjustable in order to adjust the door leaf in the height.

7. Door as claimed in claim 6, further comprising height-adjustable spacing means between the bases of the U-shaped cross-sections of the first and the second profile for the purpose of adjusting the distance between said bases.

8. Door as claimed in claim 2, wherein the cross-section of the second profile is dimensioned such that the legs of the U-shaped cross-section of the first profile embrace the second profile, such that the first profile engages, optionally clampingly, on the second profile.

9. Door as claimed in claim 2, further comprising at least a third elongate profile which extends in the width direction of the door and is formed and dimensioned such that it engages, optionally clampingly, on the second profile.

10. Door as claimed in claim 9, wherein the third profile is arranged for moving slidably along the vertical axis relative to the second profile.

11. Door as claimed in claim 2, wherein the door leaf comprises close to at least one of the underside and the upper side of the door leaf a recess extending in the width direction of the door for at least partially receiving therein at least one of the first, the second and the third profile.

12. Door as claimed in claim 2, wherein the second profile comprises close to a longitudinal outer end thereof a recess for receiving therein a mounting part of the hinge element.

13. Door as claimed in claim 12, wherein the hinge element comprises a pivot hinge and the recess is configured to receive therein a pin of the pivot hinge.

14. Door as claimed in claim 2, wherein the hinge element comprises a pivot hinge and the second profile comprises close to a longitudinal centre thereof a recess for receiving therein a pin of the pivot hinge.

15. Door as claimed in claim 13, wherein the pivot hinge comprises:
a mounting part for mounting the pivot hinge on the floor or the ceiling; and
a locking mechanism for locking the door in a plurality of predetermined angular positions relative to a frontal plane of the wall.

16. Door as claimed in claim 15, wherein the locking mechanism comprises a locking member arranged in the second profile under spring pressure, and locking holes formed correspondingly to the locking member and arranged in the mounting part at a mutual distance along a circle, wherein the locking member is resiliently movable between a rest position, in which the locking member extends into one of the locking holes in the mounting part, and a retracted position in which the locking member is situated at least substantially wholly in the second profile.

17. Door as claimed in claim 16, wherein an outer wall of the locking member and/or an inner wall of each of the locking holes is chamfered or rounded such that the locking member can be carried from its retracted position to its rest position in a manner in which it snaps into the locking holes only by means of rotation of the door, and vice versa.

18. Door as claimed in claim 2, wherein the hinge element comprises a paumelle hinge, and the second profile is configured close to a longitudinal outer end thereof for mounting thereon a mounting part of the paumelle hinge.

19. Door as claimed in claim 2, wherein the hinge element comprises a spring element and/or a spring mechanism for urging the door into a predetermined position using spring force.

20. Door as claimed in claim 1, wherein the door leaf is manufactured from at least one from the group of the following materials: steel, glass, plastic and wood.

21. Door as claimed in claim 1, wherein the door leaf comprises a self-supporting construction.

22. Door as claimed in claim 21, wherein the self-supporting construction comprises first and second shells disposed parallel to each other and opposite each other and extending in the plane of the partition wall, wherein the first and second shells are thermally disconnected from each other.

23. Door as claimed in 22, wherein the first and second shells are manufactured from steel, wherein a fire-resistant material, such as a gypsum fibre board, is arranged between the first and second shells in order to thermally disconnect the first and second shells from each other.

24. Partition wall comprising:
a horizontal upper post to be mounted on a ceiling;
a horizontal lower post to be mounted on a floor; and
a wall element, comprising at least a wall panel, to be arranged between the upper post and the lower post,
wherein a door is arranged at least substantially directly against an end surface of the wall element, and
wherein the wall panel and the door leaf of the door have the same height dimension and at least the lower post extends up to the door, such that the lower post does not extend under the door.

25. Partition wall as claimed in claim 24, wherein the upper post extends up to the door, such that the upper post does not extend above the door.

26. Partition wall as claimed in claim 24, wherein the wall panel and the door leaf are arranged at the same height above the floor, such that a horizontal lower edge of the wall panel and a horizontal lower edge of the door leaf lie mutually in line at the same height above the floor.

27. Partition wall as claimed in claim 24, wherein the wall element comprises a first and a second wall panel extending parallel to each other between an upper side and an underside of the wall element, wherein the wall element is configured close to the upper side and the underside thereof to be arranged standing upright between the horizontal upper post and the horizontal lower post, wherein an elongate profile extending between the upper and underside is arranged between the first and the second wall panel close to a lateral end surface of the wall element, and one of the first and the second wall panel extends beyond the other of the first and the second wall panel in horizontal direction, and wherein an elongate covering element extending between the upper side and underside is arranged on the profile on an outer side of the lateral end surface.

28. Partition wall as claimed in claim 24, wherein the profile has an at least substantially U-shaped cross-section comprising a base and two legs, wherein the covering element is arranged on the base and wherein each leg comprises a laterally outward directed wing.

29. Partition wall as claimed in claim 24, wherein the covering element has an at least substantially L-shaped cross-section, comprising a first leg extending in the depth direction of the wall element and a second leg lying at least substantially perpendicularly thereof and extending in the width direction of the wall element, wherein the covering element is arranged such that the first leg covers the profile and the second leg covers at least a portion of the one of the first and the second wall panel which extends beyond the other of the first and the second wall panel in horizontal direction.

30. Partition wall as claimed in claim 27, wherein the covering element and/or the profile is made at least partially of a heat-insulating material in order to thermally disconnect the first and second wall panels from each other.

31. Partition wall as claimed in claim 24, wherein the wall element and the door are manufactured from the same material, wherein the material is chosen from the following group of materials: steel, glass, plastic and wood.

32. Partition wall as claimed in claim 24, wherein the lower post and/or the upper post comprise a first, second and third elongate profile with a U-shaped cross-section, wherein the first profile is mounted with a base of its U-shaped cross-section on the floor, wherein the second profile is arranged on the first profile, wherein bases of the U-shaped cross-sections of the first and the second profile are directed away from each other, wherein the third profile is arranged between the first profile and the second profile, wherein bases of the U-shaped cross-sections of the first and third profiles are directed away from each other.

33. Partition wall as claimed in claim 32, wherein the base of the U-shaped cross-section of the second profile comprises a resilient clamping profile arranged thereon, and wherein the wall panel comprises, arranged on its lower edge, an inward extending tongue arranged clampingly between the base of the U-shaped cross-section of the second profile and the resilient clamping profile in order to attach the wall panel to the lower post and/or the upper post.

34. Partition wall, comprising at least a first and a second door as claimed in claim 13 to be arranged between a ceiling and a floor, wherein each of the first and the second door is movable between a closed position, in which a frontal plane of the door lies in a frontal plane of the partition wall, and an open position in which the frontal plane of the door lies at an angle relative to the frontal plane of the partition wall,
wherein the first door and the second door are arranged adjacently of each other such that together they form one at least substantially continuous surface in their closed position, such that they collectively function as one wall element of the partition wall.
